(19) United States
(12) Patent Application Publication
(10) Pub. No.: US 2025/0378847 A1
(43) Pub. Date: Dec. 11, 2025

(54) Novel DFH Bulge by Heat Sink Design

(71) Applicants: SAE Magnetics (H.K.) Ltd., Shatin, NT (HK); Headway Technologies, Inc., Milpitas, CA (US)

(72) Inventors: Siu Yin Ngan, San Jose, CA (US); Kowang Liu, Fremont, CA (US); Ellis Cha, San Ramon, CA (US)

(21) Appl. No.: 18/738,440

(22) Filed: Jun. 10, 2024

(51) Int. Cl. G11B 5/40; G11B 5/00; G11B 5/127

(52) U.S. Cl. CPC G11B 5/40; G11B 5/1278; G11B 5/3133; G11B 5/3136; G11B 5/314; G11B 5/607; G11B 2005/0021

(57) ABSTRACT

A PMR read/write head configured for heat assisted magnetic recording (HAMR), produces a thermally active bulge when a current is passed through a heater element formed on a centrally recessed heat sink mounted on a read shield. When the heater element is activated by a current, a bulge is formed by thermal expansion of the centrally recessed heat sink and symmetric pairs of bumper pads are formed. These thermally activated bumper pads act like symmetrically shaped nano-bumpers and provide enhanced touchdown (TD) protection to a reader (or writer) element. The PMR read/write head is mounted on a slider and the assembly is incorporated into a hard disk drive (HDD).

### RELATED PATENT APPLICATION

This application is related to docket number SM23-002, US Patent application number ______, filed on, ______, which is incorporated by reference in its entirety, and assigned to a common assignee.

### 1. TECHNICAL FIELD

This disclosure relates to magnetic read/write heads that write on and read magnetic recording media, particularly to a design of such heads that offers thermally activated protection against media damage during dynamic events such as operating shocks, load/unload processes and emergency power-off.

### 2. BACKGROUND

Hard disk drives (HDD) have been increasing the recording density of the magnetic disks on which data storage occurs. Correspondingly, the thin-film magnetic heads used to write and read that data have been required to improve their performance as well. The thin-film read/write heads most commonly in use are of a composite type, having a structure in which a magnetic-field detecting device, such as a giant-magnetoresistive (GMR) read sensor, is used together with a magnetic recording device, such as an electromagnetic coil inductive device. These two types of devices are laminated together and mounted on a rectangular solid prism-shaped device called a slider. The slider literally flies over the rotating surface of the disk, being held aloft by aerodynamic forces at a height called the fly height (FH). The read/write head is mounted in the slider where it serves to read and write data signals, respectively, from/onto magnetic disks which are the usual magnetic recording media in a HDD. The magnetic writer portion of the read/write head is a small electrically activated coil that induces a magnetic field in a pole. The field, in turn, emerges at a narrow write gap (WG) and can change the direction of the magnetic moments of small magnetic particles, or groups of particles, embedded in the surface of the disk. If the embedded particles are embedded in such a way that their moments are perpendicular to the disk surface and can be switched up and down relative to the plane of that surface, then you have what is called perpendicular magnetic recording (PMR). The perpendicular arrangement produces a more densely packed region for magnetic recording.

Perpendicular magnetic recording (PMR) heads, which record in a direction perpendicular to the plane of the recording media, have made it possible to extend the ongoing increase in the recording density of hard disk drives (HDD) beyond 100 Gb/in2. However, even using PMR heads, it is difficult to extend the density beyond 1 Tb/in2 due to thermal stability of the media and the media's super-paramagnetic limit. In order to achieve a higher recording density, a new technology has been developed: Heat Assisted Magnetic Recording (HAMR). Briefly, the media that can be effectively used to record at these ultra-high densities must have extremely high coercivities so that data, once it is recorded, can remain stable even when subjected to thermal effects. Unfortunately, the high coercivities required to maintain the data once it is recorded, also makes it difficult for the limited flux densities of the small PMR heads to actually create magnetic transitions and record that data into the media. One way to do this, is to heat the recording media during the actual recording process so that its coercivity is temporarily reduced and then to record the data on the heated surface. When the surface cools, the coercivity is restored to its ambient value and the recorded data becomes stable.

As is well known, a typical HAMR head is a read/write head (a slider-mounted PMR head in the present case) that is furnished with: (1) a Laser diode to provide optical thermal energy via optical radiation, (2) an optical waveguide to transfer that radiation close to the recording surface, and (3) a plasmon generator located near that surface.

The plasmon generator is a device that receives the optical radiation, converts it, by electromagnetic coupling to the excitation of plasmon modes and then transfers energy from the plasmon near-fields to a region of the recording media. The near-fields, not being radiative, are not subject to diffraction effects and can be highly localized. The localized near-field energy appears as a near-field spot at the tip of the plasmon generator's air bearing surface (ABS). This tiny near field spot emerges at the ABS of the PMR read/write head adjacent to the emerging magnetic pole tip of the write portion of the PMR. During write operations, the emerging near-field spot induces a very localized temperature rise in the recording media to assist magnetic writing. At the same time, the near-field energy induces a very sharp or localized thermally-induced protrusion on the recording head that causes many issues that should be dealt with. Note that this disclosure will address the read/write head and not provide any additional description of these HAMR components that produce the near-field spot as they are now well known in the field and features of the HAMR head, where the near-field energy is deposited and the read/write operations occur. As a result, HAMR drives use glass substrate media to remedy this issue

To remedy the reader temperature issue, a read heater heat sink is added between the read heater and the read shield to generate a read heater bulge.

### SUMMARY

The first object of this disclosure is to provide touchdown (TD) protection to various portions of a HAMR write head by the addition of “active” bumper pads that are produced by the thermal expansion of a center-recessed heat sink whose shapes are thermally modified by the effects of heat already being produced within the write head.

The second object of this disclosure is to provide such bumper pads which are caused to protrude (from a region where there is a thermal bulge) by the effects of heat already being generated by elements within the HAMR head and wherein the protrusion increases TD contact area and can control the minimum point (closest to the disk) location so that it is away from sensor locations to improve reliability.

The third object of this disclosure is to provide such bumper pads whose global and local protrusion effects will cause points of TD contact to be shifted to shields and other regions that are designed to absorb contacts and thereby to avoid contacts with more sensitive areas of the write head.

A fourth object of this disclosure is to provide bumper pads whose shapes can be controlled to create thermal protrusion asymmetries that may be advantageous for the performance of the HAMR write head.

The objects of this disclosure will be realized by the design of a HAMR read/write head configured for perpendicular magnetic recording (PMR) that includes a magnetically shielded GMR read head and a separate, magnetically shielded inductive write head that is activated by a write current. These elements emerge at an ABS of the PMR. The PMR also contains independently operating heater elements, Hr and Hw, that are disposed adjacent to said read head and said write head respectively, but are proximally away from said ABS. The PMR also contains at least one HDIs (head-disk interference sensor that is mounted in the read/write head. In order to make use of the HAMR system, the write head forms a narrow writing region at its ABS where magnetic flux is emitted by an emergent magnetic pole tip and where near-field plasmon energy emerges at a trailing edge of said pole tip to enable writing on a disk medium. Finally, a pair of thermally active bumper pads, whose shapes are modified by local thermally-induced protrusions, are disposed to either side of the narrow writing region of the write element to protect said region in the event of a touchdown (TD) or other forms of head-disk interference (HDI) by shifting points of possible disk contacts away from the write head and towards the magnetic shields.

### BRIEF DESCRIPTION OF THE DRAWINGS

FIG. 1 is a schematic view of a prior art HAMR head. showing a heat sink between a read heater and a read shield.

FIG. 2A is a conventional heat sink and read heater.

FIG. 2B is a center-recessed heat sink for the disclosed DFH bulge.

FIGS. 3A and 3B show a slider center read heater bulge above a conventional DFH bulge, in down-track and cross-track directions, respectively.

FIGS. 3C and 3D show a slider center read heater bulge above a novel DFH bulge in down-track and cross-track directions, respectively.

FIGS. 4A-4D show read flying height (FH) profiles during a read touchdown (TD), with FIG. 4A-4B showing a conventional bulge and in down-track and cross-track directions, respectively, And FIGS. 4C and 4D showing the present disclosed bulge and in down-track and cross-track directions, respectively.

FIG. 5A shows a touchdown (TD) area produced by a conventional bulge.

FIG. 5B shows a touchdown (TD) area produced by the bulge of the present disclosure.

FIG. 6 shows a head gimbal assembly (HGA) on which the disclosed PMR head is flexibly mounted.

FIG. 7 shows a side view of a pair of HGA's, such as those shown in FIG. 6.

FIG. 8 shows an overhead view of the figure in FIG. 8.

### DETAILED DESCRIPTION

To reduce reader temperature rise induced by an activated read heater, a heat sink is placed between S1 reader shield and read heater. Read element (GMR element) is located between S1 and S2A. read shields. FIG. 1 shows the read heater (10), shields (30), (35) and heat sink (20) structures, Also shown is a portion, (100) of the writing coil, but this will not be dealt with.

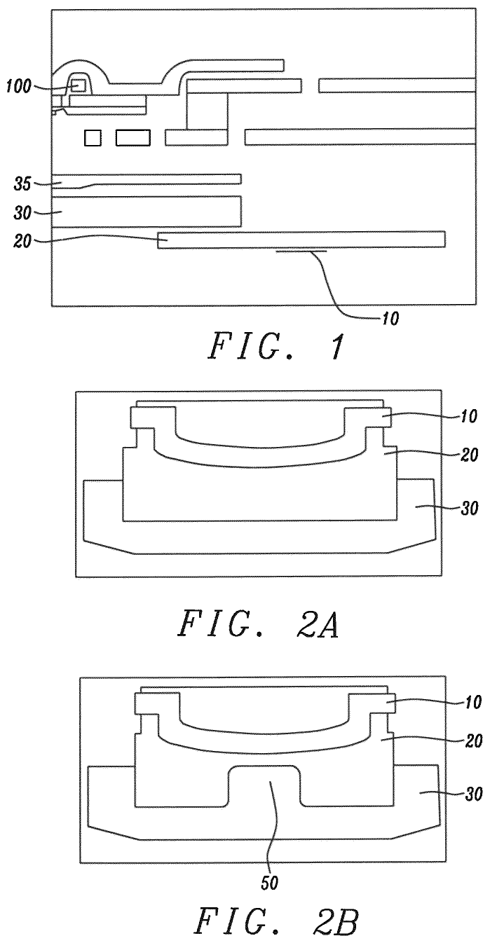

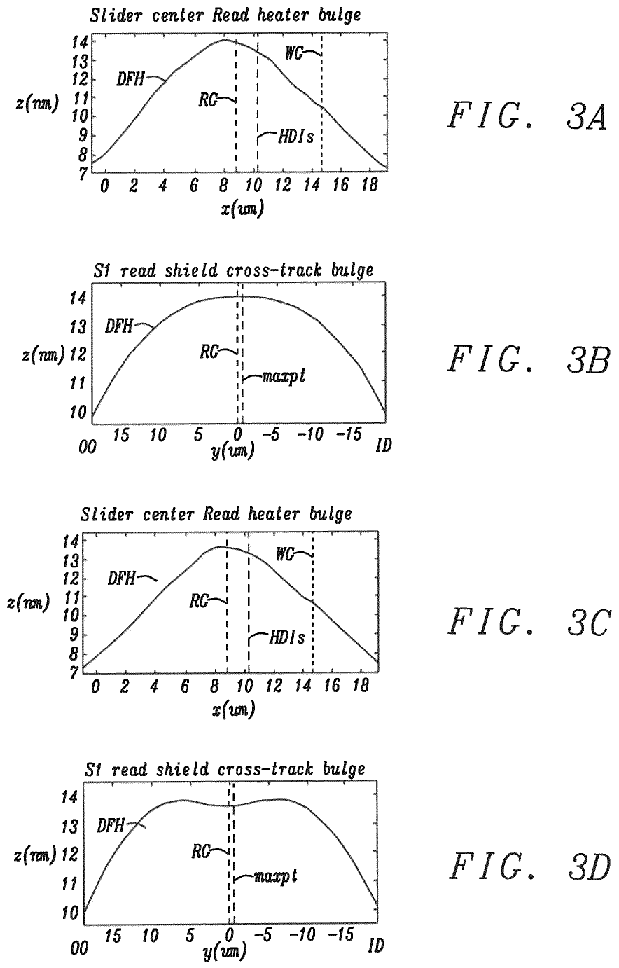

In read heater operation the read heater transfers heat to a heat sink, then the heat sink transfers the heat to the S1 read shield. A heater bulge is generated by the thermal expansion of the heat sink and read shields. Since the read heater is not directly heated up by the S1 shield, reader temperature is reduced effectively after insertion of the heat sink. However, the shape of the heater bulge becomes insensitive to the shape of the read heater. Heat sink design proposed that will achieve a novel bulge that will protect the reader. FIG. 2A shows the conventionally shaped heat sink and read heater and FIG. 2B shows the present heat sink and read heater.

The read heater bulge actuates reader spacing and delivers sufficient TD area to trigger TD vibration in the read heater TD. FIGS. 3A and 3B show the conventional read heater bulge, in down-track and cross-track directions, respectively. FIGS. 3C and 3D show the present novel read heater bulge, in down-track and cross-track directions, respectively. The maximum protrusion point of the conventional heater is located at the slider center and very close to the reader element. However, the presently described bulge has double peaks that act like nano bumpers and splits the maximum protrusion points+/−6 (micrometers) away from the center in the cross-track direction. Reader position is at the center (not the protrusion peak) and the double-peaks (nano-bumpers) to protect the reader element from HDI/TD wear.

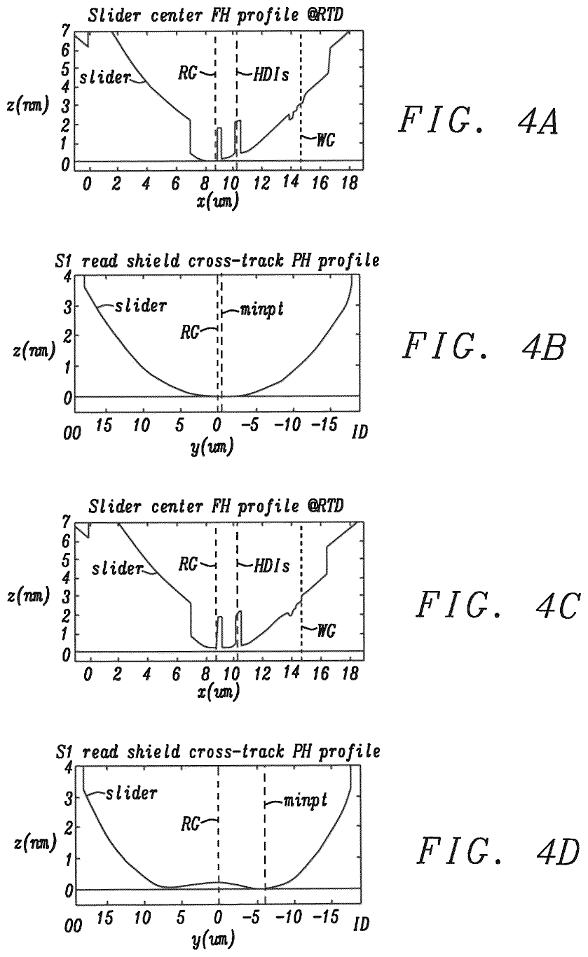

FIGS. 4A-4D show read flying height (FH) profiles during a read touchdown (TD), with FIG. 4A-4B showing a conventional bulge and in down-track and cross-track directions, respectively, And FIGS. 4c and 4D showing the present disclosed bulge and in down-track and cross-track directions, respectively. Reader spacing of the conventional read heater is less than 0.1 nm (nanometer), (1A). The present DFH bulge design delivers the “nano-bumpers” to protect the reader element during a RTD. Reader spacing is 0.3 nm @RTD (reader touchdown) using the presently designed heat sink with the original read heater. The reader spacing can be adjusted from 0 to 1 nm by the heat sink shape being fine tuned depending on the HDI/TD wear from HDD.

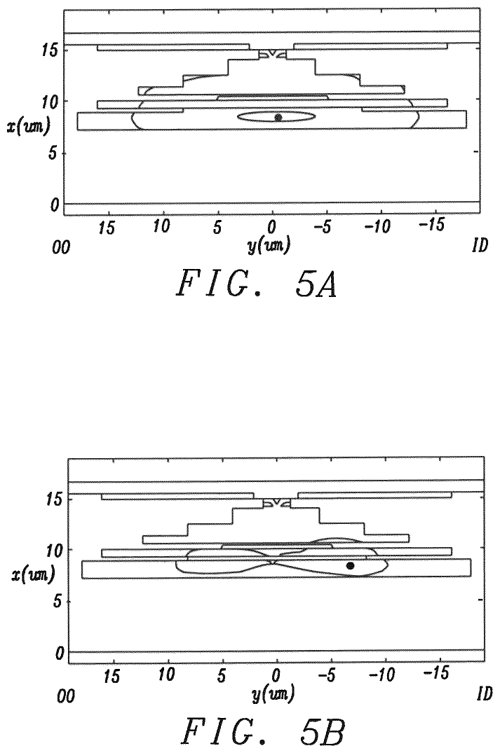

Moreover, the presently designed DFH bulge delivers wider bulge width compared to the conventional bulge. It increases TD area to trigger sufficient TD vibration in drive. FIG. 5A shows conventional read TD area is 108 (micrometers\hat{ }2), the presently described bulge increases the read TD area to 122 (micrometers\hat{ }2) as is shown in FIG. 5B. The bulge width and maximum protrusion position can be adjusted by fine tuning the heat sink design.

Based on the modeling results shown in the figures, we see that this design offers many advantages, including:
1) Control of contact area magnitude to prevent TD “overpush” (overcompensation of heater power due to poor detection of TD) by bumper's dimension and protrusion.
2) Control of minimum point shift away from sensor, to bumper pads, for head reliability.
3) Adjustability of bumper local protrusion height and shape by choice of bumper dimension for different wafer designs, head processes and write conditions.
4) The presently described DFH bulge has double peaks
5) Control of contact area magnitude to prevent TD “overpush” (overcompensation of heater power due to poor detection of TD) by bumper's dimension and protrusion.
6) Control of minimum point shift away from sensor, to bumper pads, for head reliability.
7) Adjustability of bumper local protrusion height and shape by choice of bumper dimension for different wafer designs, head processes and write conditions.
8) Double peaks that act as “nano-bumpers” to protect reader from HDI/TD wear by shifting the DFH TD points from center to the nano-bumpers (side of S1 read shield).
9) Reader spacing @TD is 0.3 nm in the disclosed design. It can be adjusted from 0 nm to 1 nm by the heater design being fine tuned according to the HDI/TD wear conditions in the HDD.
10) The presently disclosed DFH bulge increases the TD area from 55 micro-meters\hat{ }2 to 88 micro meters\hat{ }2 for sufficient TD vibration.

FIG. 6 shows a head gimbal assembly (HGA) 1200 that includes a slider-mounted PMR writer 1100, the slider now providing aerodynamic support to the writer when it moves above or below an operational disk recording medium 1140. There is also shown a suspension 1220 that elastically supports the slider-mounted writer 1100. The suspension 1220 has a spring-like load beam 1230 made with a thin, corrosion-free elastic material like stainless steel. A flexure 1230 is provided at a distal end of the load beam and a base-plate 1240 is provided at the proximal end. The slider mounted TAMR writer 1100 is attached to the load beam 1230 at the flexure 1231 which provides the TAMR with the proper amount of freedom of motion. A gimbal part for maintaining the PMR read/write head at a proper level is provided in a portion of the flexure 1231 to which the TAMR 1100 is mounted.

A member to which the HGA 1200 is mounted to arm 1260 is referred to as head arm assembly 1220. The arm 1260 moves the read/write head 1100 in the cross-track direction (arrow) across the medium 1140 (here, a hard disk). One end of the arm 1260 is mounted to the base plate 1240. A coil 1231 to be a part of a voice coil motor (not shown) is mounted to the other end of the arm 1260. A bearing part 1233 is provided to the intermediate portion of the arm 1260. The arm 1260 is rotatably supported by a shaft 1234 mounted to the bearing part 1233. The arm 1260 and the voice coil motor that drives the arm 1260 configure an actuator.

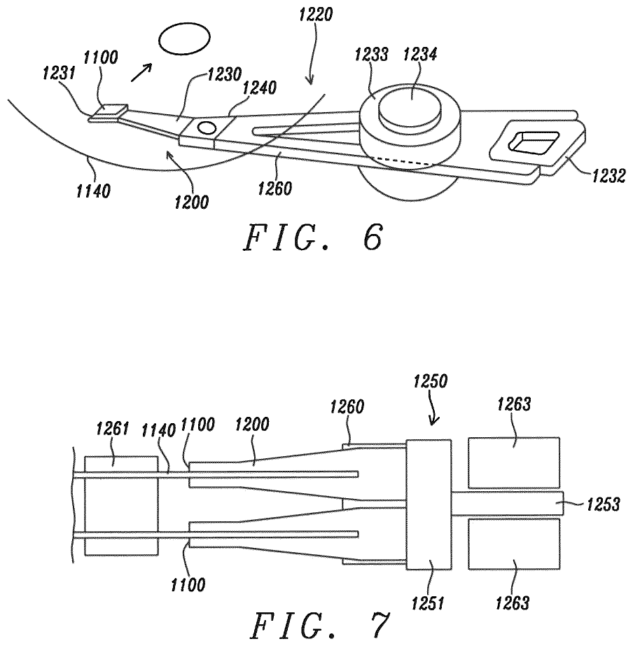

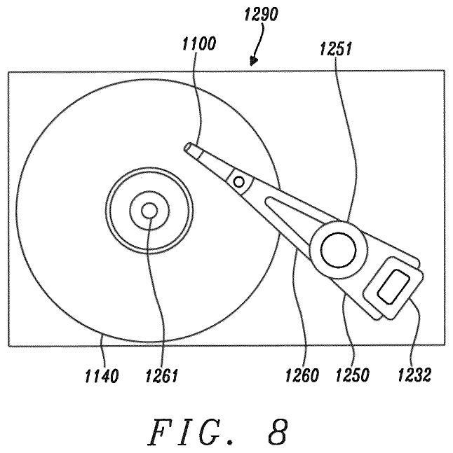

Referring next to FIG. 7 and FIG. 8, there is shown a head stack assembly 1250 and a magnetic recording apparatus in which the slider-mounted TAMR writer 1100 is contained. The head stack assembly is an element to which the HGA 1200 is mounted to arms of a carriage having a plurality of arms for engaging with a plurality of disks 1140. The plurality of disks are mounted on a spindle 1261. FIG. 5 is a side view of this assembly and FIG. 6 is a plan view of the entire magnetic recording apparatus.

Referring finally to FIG. 8, the head stack assembly 1250 is shown incorporated into a magnetic recording apparatus 1290. The magnetic recording apparatus 1290 has a plurality of magnetic recording media 1114 mounted on a spindle motor 1261. Each individual recording media 1114 has two TAMR elements 1100 arranged opposite to each other across the magnetic recording media 14 (shown clearly in FIG. 5). The head stack assembly 1250 and the actuator (except for the write head itself) act as a positioning device and support the PMR heads 1100. They also position the PMR heads correctly opposite the media surface in response to electronic signals. The read/write head records information onto the surface of the magnetic media by means of the magnetic pole contained therein.

As is understood by a person skilled in the art, the present description is illustrative of the present disclosure rather than limiting of the present disclosure. Revisions and modifications may be made to methods, materials, structures and dimensions employed in forming and providing a HDD slider-mounted PMR recording head configured for HAMR, the slider having an ABS topography that includes a symmetrically positioned, center recessed heater bulge and active bumper pads formed from the centrally recessed type of heat sink and symmetrically surrounding a narrow writer region that is configured to operate in conjunction with a plasmon near-field spot and wherein the thermally active bulge provides shape alterations, resulting from thermal protrusion effects generated within said PMR, where the shape alterations provide protection to portions of said PMR head during intentional and unintentional TDs while still forming and providing such a device and its method of operation in accord with the spirit and scope of the present disclosure as defined by the appended claims.

What is claimed is:

1. A Heat Assisted Magnetic Recording (HAMR) read/write head comprising:
a Perpendicular Magnetic Recording (PMR) read/write head configured for HAMR; wherein
said PMR read/write head comprises a magnetically shielded giant magneto resistance (GMR) read head and a separate, magnetically shielded inductive write head that is activated by a write current, said elements emerging at an ABS of said PMR; wherein;
independently operating read and write heater elements, Hr and Hw, are disposed adjacent to said read head and said write head respectively, but are proximally away from said ABS; and wherein
said read heater is mounted on a center-recessed heat sink which is itself mounted on said heater shield and the resulting structure produces a double-peak dynamic flying height (DFH) bulge or, wherein, a multi-recessed heat sink produces a multi-peak DFH bulge, and wherein
said bulge produces a pair of thermally active nano-bumper pads, whose shapes are modified by local thermally-induced protrusions formed by said bulge, are disposed to either side of said narrow writing region of said write element to protect said region in the event of a read touchdown (RTD) or other forms of head-disk interference (HDI), by shifting points of possible disk contacts towards said protrusions.

2. The HAMR read/write head of claim 1 wherein said pair of thermally active bumper pads produced from said bulge extend proximally away from said ABS and are configured to absorb thermal energy generated from said heaters, from said write current and from said HAMR apparatus, whereby said bumper pads thermally protrude and provide increased surface areas and enhanced protection to said write head during intentional or accidental read touchdown (RTD) or other forms of head/disk interference (HTI) events.

3. The HAMR read/write head of claim 1 wherein both said active bumper pads are identically shaped and symmetrically positioned, whereby each said active bumper pad produces a similar protrusion as said other active bumper pad when thermally activated, thereby altering the response of said slider symmetrically in a cross-track direction under conditions of a TD.

4. The HAMR read/write head of claim 1 wherein both said active bumper pads are identically shaped and act like identical nano-bumpers with surfaces extending proximally rearward away from said ABS and passing over inductive magnetic coil elements whereby each said active bumper pad absorbs heat generated by said magnetic coil elements during write processes.

5. The HAMR read/write head of claim 1 wherein each said active bumper pad is shaped the same as the other, whereby each said active bumper pad produces a similarly shaped protrusion from said other active bumper pad when pads are thermally activated, thereby altering the response of said slider under conditions of a TD in a symmetric manner and wherein said double-peaked DFH bulge can protect a read transducer, a write transducer or a HAMR near-field transducer and provide improved transducer reliability.

6. The HAMR read/write head of claim 1 wherein shapes of said thermally active bumper pads are adjusted by said bulge shape, wherein said bulge shape is the nano-bumper height and is adjusted by fine-tuning said heat sink according to HDI/TD wear conditions in said HDI.

7. The HAMR read/write head of claim 1 wherein, during a touchdown (TD), said thermally active bumper pads shift the point of minimum approach to said disk medium of said slider ABS away from said HDIs and to said active bumper pads, to improve both TD detection and head reliability.

8. The HAMR read/write head of claim 1, whereby adjusting the size and shape of each said active bumper pad and said distance between said two bumper pads makes said active bumper pads adaptable to different head designs, write conditions and head fabrication processes.

9. A slider-mounted HAMR read/write head comprising:
said HAMR read/write head of claim 1 mounted on a slider, said slider being aerodynamically configured to maintain said HAMR read/write head at a fly height when said slider is suspended above a rotating magnetic recording disk and wherein thermal protrusions of said active bumper pads control a minimum fly height point of said slider during touchdown (TD) events.

10. The slider mounted HAMR read/write head of claim 9 wherein thermal protrusions caused by said active bumper pads increase the area of said slider ABS in closest approach of a disk medium during a touchdown (TD) event, whereby said HDIs are brought uniformly closer to said disk medium and said TD event is more easily detected by said HDIs.

11. The slider mounted HAMR read/write head of claim 9 wherein said active bumper pads shift a point of minimum approach to a touchdown (TD) of said slider ABS away from sensitive regions exposed on said ABS to larger shields and, therefore, to improve head reliability.

12. The slider mounted HAMR read/write head of claim 9 wherein said active bumper pads shift a point of minimum approach in a touchdown (TD) of said slider ABS away from sensitive regions exposed on said ABS to larger shields and, therefore, to improve head reliability.

13. The slider mounted HAMR of claim 9 wherein reader spacing @TD is 0.3 nm in the disclosed design, but wherein said spacing can be adjusted from 0 nm to 1 nm by said heater design being fine-tuned according to the HDI/TD wear.

14. The slider mounted HAMR of claim 9 wherein said presently disclosed DFH bulge increases said TD area from 108 micro-meters\hat{ }2 to 122 micro-meters\hat{ }2 for sufficient TD vibration.

15. The slider mounted HAMR of claim 9 wherein said DFH bulge provides control of contact area magnitude to prevent TD “overpush”, overcompensation of heater power due to poor detection of a TD, by bumper's dimension and protrusion.

16. The slider mounted HAMR of claim 9 wherein control of minimum point-shift away from sensor and to said bumper pads, provides for reduction of wear and increased head reliability.

17. A head gimbal assembly (HGA) comprising:
(a) the HAMR device of claim 1 and
(b) a suspension that elastically supports said HAMR device, wherein said suspension has a flexure to which said HAMR device is joined, a load beam with one end connected to said flexure and with a base plate connected to the other end of the load beam.

18. A magnetic recording apparatus comprising:
(a) the HGA of claim 17,
(b) a magnetic recording medium positioned opposite to a slider on which said magnetic read head structure is formed,
(c) a spindle motor that rotates and drives the magnetic recording medium, and
(d) a device that supports the slider and that positions the slider relative to the magnetic recording medium.
